(19) United States
(12) Patent Application Publication
(10) Pub. No.: US 2004/0138985 A1
(43) Pub. Date: Jul. 15, 2004

(54) Automated exchange system for trading foreign exchange

(76) Inventors: Jonas Lundberg, Stockholm (SE); Ulf Ahlenius, Bromma (SE)

Correspondence Address: NIXON & VANDERHYE, PC, 1100 N GLEBE ROAD, 8TH FLOOR, ARLINGTON, VA, 22201-4714, US

(21) Appl. No.: 10/339,644

(22) Filed: Jan. 10, 2003

(51) Int. Cl. G06F 17/60

(52) U.S. Cl. 705/37

(57) ABSTRACT

In an automated exchange system, each matched foreign exchange contract is forwarded to a deal capture module where each deal is split into its base components, legs, and wherefrom each leg is reported to a position keeping system, which can net out different positions taken by each party as a result of the deals the party enter. The position keeping system can then forward the data for further processing, such as settlement.

### TECHNICAL FIELD

The present invention relates to an automated exchange system and in particular to a system for trading foreign exchange.

### BACKGROUND OF THE INVENTION AND PRIOR ART

Today, foreign exchange trades are usually done over the telephone. The trades are traditionally executed using a few currencies having a high liquidity as a reference currency.

The reference currency/currencies can for example be US dollars (USD) British pounds (GBP), Euro (EUR), or Japanese yen (JPY). The most common reference currency is USD. When a trade between two currencies (other than the reference currency) is carried out therefore involves two different trades, one trade for the first currency against the reference currency and one trade for the second currency against the reference currency to complete the trade between the first and second currency.

The trades, when performed, are then reported and settled. However the settlement usually takes a few days. This in turn leads to that the parties involved in the trades are left with many long and short positions.

This is not desired since the positions constitute a risk for the parties.

### SUMMARY

It is an object of the present invention to provide a method and a system whereby the positions of the parties involved in trading of foreign exchange can be reduced, and thereby the risks associated therewith.

This object and others are obtained by the present invention as set out in the appended claims.

Hence, in accordance with the present invention, each matched foreign exchange contract is forwarded to a deal capture module where each deal is split into its basic components, legs, and wherefrom each leg is reported to a position keeping system, which can net out different positions taken by each party as a result of the deals the party enter. The position keeping system can then forward the data for further processing, such as settlement.

### BRIEF DESCRIPTION OF THE DRAWINGS

The present invention will now be described in more detail by way of non-limiting examples, and with reference to the accompanying drawings, in which:

FIG. 1 is a general view of an automated system for trading foreign exchange,

FIG. 2 is a flow chart illustrating a foreign exchange in accordance with a first embodiment,

FIG. 3 is a flow chart illustrating a foreign exchange in accordance with a second embodiment,

### DESCRIPTION OF PREFERRED EMBODIMENTS

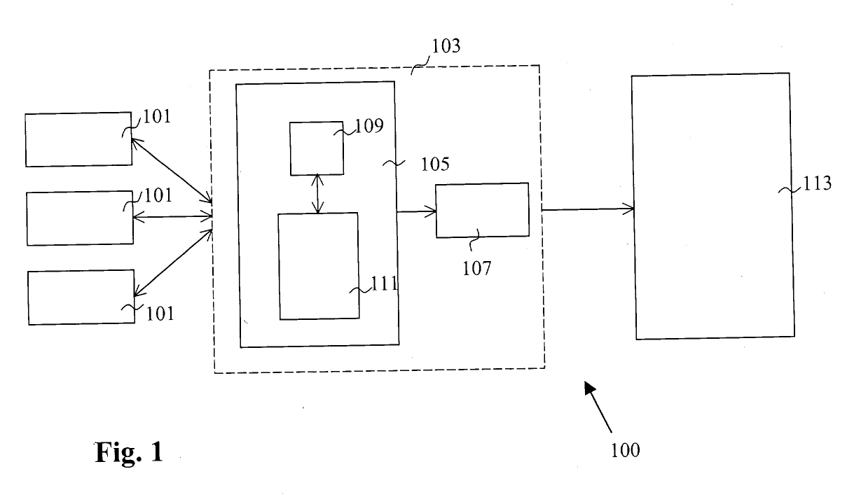

In FIG. 1, a view of a system for trading foreign exchange is depicted. The system comprises a number of remote input terminals 101 and a central execution unit 103. The unit 103 in turn comprises a matching unit 105 and a deal capture module 107. The module 107 is responsible for performing tasks such as receiving and register a deal in a designated database and reply to requests relating to closed deals. Also, if a deal needs to be cancelled/altered, this is normally performed in the deal capture module. The matching unit 105 is formed by a processor unit 109 and a memory 11 associated therewith. Also, in accordance with a preferred embodiment the system is connected to a position keeping system 113. The position keeping system keeps track of the current positions for all parties trading in the system.

The matching unit receives order information entered into the system from the terminals 101 and is designed to match orders in accordance with specified rules. The outcome of a successful match from the matching unit is, in accordance with the present invention, forwarded to the deal capture module 107.

The deal capture module 107 receives all information relating to the matched orders and splits the deal into at least four legs or sub-contracts. Depending on the nature of the deal there may be more than four legs. A deal in a currency trade will comprise a first leg relating to a first party selling a currency, a second leg relating to the first party buying a currency, a third leg relating to a second party buying a currency and a fourth leg relating to the second party selling a currency. As indicated above, deal may comprise more than four legs. This is for example the case when the deal relates to a trade of combination contracts.

The deal split into its different legs is then transmitted to other parts of the system or to receivers located outside the system. In particular the (at least) four legs of the deal may be forwarded to a position keeping system 113. The position keeping system can then up-date the positions of each party accordingly. This will make possible netting of positions on a day to day basis or another time period specified in the system. The positions of the position keeping system can then be forwarded to settlement on a suitable time base, e.g. on a daily basis.

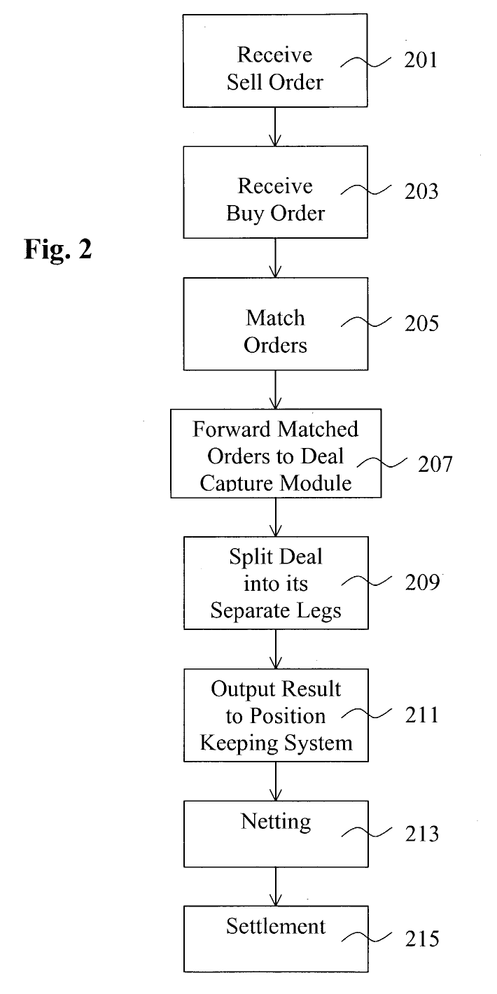

In FIG. 2, a flow chart illustrating an exemplary trade in the system of FIG. 1 in accordance with a first embodiment is shown. In the example it is assumed that the trading system uses US dollars (USD) as reference currency. First, a first trader A enters an order to sell a particular currency contract. For example an order to sell 100 contracts of Swiss francs (CHF) at a particular exchange rate. The sell order is then transmitted to the central matching system, where it is received step 201.

Next, a second trader B enters an order to buy a corresponding currency contract. For example an order to buy 100 contracts Swiss francs (CHF) at an exchange rate matching the sell order input by trader A. The buy order is then transmitted to the central matching system. The order is received by the system, step 203.

The orders transmitted from the first and second trader is then directed to the matching unit of the central system for matching. In this case, the orders received in steps 201 and 203 match.

Once matched in the matching unit, step 205, the outcome of the match is forwarded to another entity, the deal capture module, step 207. Next, in a step 209, the deal capture module splits the deal into its legs. In this example the trade will comprise four legs. Trader A will sell 100 contracts CHF and buy X contracts USD (depending on the exchange rate at which the deal is matched). As a result Trader A will enter a short position in CHF and a long position in USD. Trader B will do the opposite. I.e. trader B will buy 100 contracts CHF and sell X contracts USD. Trader B will therefore enter a long position in CHF and a short position in USD.

Next, the legs are output from the deal capture system and forwarded to a position keeping system, step 211. In the position keeping system netting of positions taken by the different parties during the day or specified time period may take place, step 213. The positions or the net positions are then output for subsequent settlement, step 215.

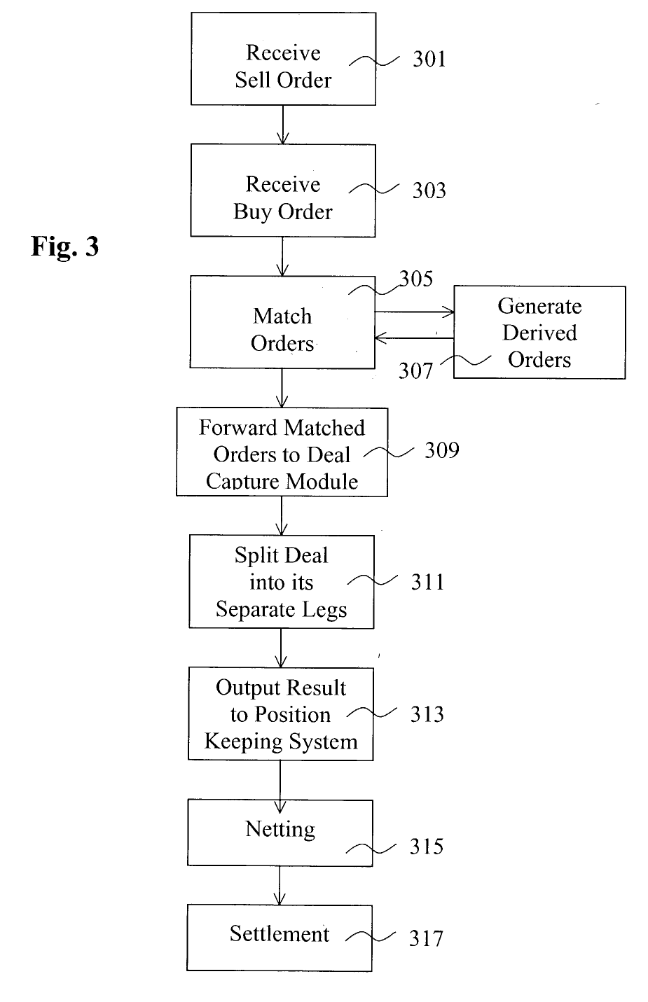

In FIG. 3, a flowchart illustrating trading of a combination is illustrated. In the example it is assumed that a Trader A enters an order to sell 100 contracts of Swedish Krona SEK in exchange for Swiss Francs CHF at a particular exchange rate, for example 6.28. It is further assumed that a trader B enters an order to buy 100 contracts of Swedish Krona SEK in exchange for Swiss Francs at a rate matching the order of trader A. Also It is assumed that the system in which the orders are matched uses USD as a reference currency.

In this example the system will first receive the order from trader A, step 301. Next, the system will receive the order from trader B, step 303. The orders received by the system are then matched. The matching is performed in a step 305. The matching may generate derived orders in the different currencies in order to increase liquidity in the market if there is no direct match of orders. This is indicated in step 307.

The information relating to the matched deal in step 305 is then forwarded to the deal capture module, step 309. Next, in a step 311, the deal capture module splits the deal into its legs. Since the reference currency in this exemplary system is USD, the trade will comprise the following legs. Trader A will sell 100 contracts SEK and buy X contracts USD (depending on the exchange rate at which the deal is matched). Trader A will also buy 15.93 contracts CHF and sell X contracts USD.

Trader B will buy 100 contracts SEK and sell X contracts USD (depending on the exchange rate at which the deal is matched). Trader B will also sell 15.93 contracts CHF and buy X contracts USD. The volume X bought and sold USD contracts will be triangulated. This may be performed such that first a trade in CHF/USD is made at the current market price. Next a corresponding trade in SEK/USD is performed at a price such that the amount of traded USD equals nil. The net result of these two deals formed in the deal capture module will hence be nil. The amount of USD traded should preferably be to be nil (or very close to nil) due to arbitrage. If the amount does not equal nil another trader could trade the separate parts of the trades and make risk free money.

As a result of the trade Trader A will enter a short position in SEK and a long position in CHF, a long position in USD and a short position in USD. Trader B will do the opposite. I.e. trader B will buy 100 contracts SEK and sell 6.28 contracts CHF. Trader B will therefore enter a long position in SEK, a short position in CHF, a long position in USD and a short position in USD.

Next, the legs are output from the deal capture system and forwarded to a position keeping system, step 313. In the position keeping system netting of positions taken by the different parties during the day or specified time period may take place, step 315. In this case the legs in USD will equal a nil position for both trader A and trader B. The positions or the net positions are then output for subsequent settlement, step 317.

The information relating to all trades is preferably also disseminated to the traders to other market participants and also to the clearinghouse where the trades are cleared or a CSD, depending on the exchange using the system as described herein.

1. A computerized system for automated trading of foreign exchange, the system comprising a number of remote input terminals for entering bids and offers for foreign exchange contracts, a matching unit comprising a processor and an associated memory for matching bids and offers entered into the system via the remote terminals, the matching unit being connected to a separate deal capture entity for capturing deals formed by matching bids and offers matched in the matching unit, wherein the deal capture entity comprises,
means for splitting each deal in to its components, legs.

2. A system according to claim 1, further comprising a position keeping system whereto data related to the legs of the deal is transmitted.

3. A system according to claim 2, wherein the positions in the position keeping system are netted before output for subsequent processing.

4. A system according to claim 3, wherein the subsequent processing includes settlement of netted positions.

5. A system according to claim 1, wherein the system uses at least one base currency and wherein the deal capture module is programmed to execute all trades between non-base currencies over said at least one base currency such that the resulting positions in said at least one base currency equals nil.

6. A method of automated trading of foreign exchange in a system comprising a number of remote input terminals for entering bids and offers for foreign exchange contracts, a matching unit comprising a processor and an associated memory for matching bids and offers entered into the system via the remote terminals, the matching unit being connected to a separate deal capture entity for capturing deals formed by matching bids and offers matched in the matching unit, wherein each deal is split in to its basic components, legs in said deal capture module.

7. A method according to claim 6, wherein the positions taken as a result of the deals are netted in the position keeping system before output for subsequent processing.

8. A method according to claim 7, wherein the subsequent processing includes settlement of netted positions.

9. A method according to claim 6, wherein the system uses at least one base currency and wherein all trades between non-base currencies are traded over said at least one base currency so that the netted positions in said at least one base currency equals nil.

10. A computerized system for automated trading of foreign exchange, the system comprising a number of remote input terminals for entering bids and offers for foreign exchange contracts, a matching unit comprising a processor and an associated memory for matching bids and offers entered into the system via the remote terminals, the matching unit being connected to a separate deal capture entity for capturing deals formed by matching bids and offers matched in the matching unit, the deal capture entity being programmed to split each received deal in to its components, legs before outputting the deal to a position keeping system.

11. A system according to claim 11, wherein the position keeping system is programmed to net positions before outputting data relating to a deal for subsequent processing.

12. A system according to claim 12, wherein the position keeping system is linked to a settlement system.
